(19) United States
(12) Patent Application Publication
(10) Pub. No.: US 2011/0084007 A1
(43) Pub. Date: Apr. 14, 2011

(54) Pure Sip

(76) Inventor: John James McEncroe, Golden, CO (US)

(21) Appl. No.: 12/576,645

(22) Filed: Oct. 9, 2009

(51) Int. Cl. C02F 1/34; B01D 35/143

(52) U.S. Cl. 210/86; 210/199

(57) ABSTRACT

The “Pure Sip” system will reliably address biological, as well as chemical, contamination in the distribution system after treatment at a central purification facility. The Public water supply industry relies heavily on the “multiple barrier” approach in the protection of public health; the “Pure Sip” Point of Use (POU) treatment unit/system is a logical, economical, and effective, addition to the water industry's traditional “multiple barrier” treatment strategy. The unique “Pure Sip” system incorporates 10 micron and 1.0 micron filtration, activated carbon adsorption, and 12V UV primary disinfection, in a portable countertop unit.

### REFERENCES CITED

| | | |
|---|---|---|
| 7,404,894 | Jul. 29, 2008 | Yamaguchi |
| 7,090,779 | Oct. 20, 2004 | Berstein |
| 6,478,956 | Nov. 12, 2002 | Kaura |
| 6,402,949 | Jun. 11, 2002 | Banks |
| 6,379,544 | Apr. 30, 2002 | Chen |
| 6,344,146 | Feb. 5, 2002 | Moorehead |
| 6,024,867 | Feb. 15, 2000 | Parise |
| 5,656,160 | Aug. 12, 1997 | Parise |
| 5,433,848 | Jul. 18, 1995 | Platter |
| 4,902,411 | Feb. 20, 1990 | Lin |
| 4,556,484 | Dec. 3, 1985 | Hunter |

Please note that my understanding from reading material on the USPTO website is that I am only required to document those patents granted within the past 20 years which are, or may be, related to my system (so I did not include older patents).

1. Unique countertop system (independent claim #1): Although undercounter systems are preferred from an aesthetic standpoint, they are “out of sight-out of mind” and their installation and maintenance will be perceived as problematic, or essentially impossible, by most utilities. To be successful in getting the EPA, state and local Health Departments, and Utilities, to embrace POU, they need a countertop design which eliminates the nebulous variables and costs related to undercounter installation, is convenient for the citizen and the utility to swap out every six months, and which protects the user against microbiological, inorganic, and organic contaminants. My unit is the first countertop/portable “Point of Use” system which incorporates a 10 micron particle filter, an absolute 1.0 micron filtration for inorganics and microbial removal, carbon adsorption for organics removal, and “A” rated Ultraviolet Disinfection (upstream and downstream of the particle filtration steps) in a unit designed to be portable so that it can be used wherever 12 Volt power is available (including a vehicle “lighter/power” outlet). A drawback of reverse osmosis systems is that many of the healthful minerals are removed from the water; a 1.0 micron filter will not remove these beneficial constituents.

2. Ultraviolet “Class A” microbial disinfection/inactivation which meets NSF standard 55 using 12V DC power (dependent on claim #1). (http://www.nsf.orq/business/drinking water treatment/standards.asp?program=DrinkinqW atTre). Although there are two existing systems which could conceivably be used as portable units, they are not configured to be so, nor are they rated as UV “A” (primary disinfection systems); rather, they are rated as UV “B” (secondary disinfection systems). The units are Puritec and Hydrotech:
http://www.puritec.com/store/moreinfo.cfm?Product ID=228, http://www.hydrotechwater.com/UV%20Sterilizers/pura uv b.htm. Please note that a bacteriostat, incorporated within a carbon block type filter, and designed to control the non-pathogenic heterotrophic growth frequently encountered in such a filter, would not serve as an adequate barrier in the event of a serious bacteriological contamination event within the distribution system.

3. Civil Defense purposes (independent claim #2): The system includes a 1 liter syringe with an adapter to fit onto the unit's sink tap connection to treat non potable water during civil emergencies, or while being used anywhere that the distribution system pressure is unavailable. The unit includes a flow inhibitor device to ensure adequate contact time with the UV source for disinfection, and with the carbon block filter to ensure adequate adsorption time for organics removal.

4. Chlorine test kit (dependent on claim #1): One of the biggest drawbacks of systems which use carbon adsorption for organics (and chlorine) removal is that there is no method supplied with any system to determine the efficacy of the adsorption system. It is quite possible that subsequent to a serious distribution system event, that the homeowner would mistakenly believe that adsorption is occurring, when in fact the carbon's adsorption ability has been seriously compromised or exhausted. As such, a chlorine disinfectant residual test kit is included as part of the system; absence of chlorine in the unit's effluent serves as a surrogate to verify the efficacy of the carbon block filter at adsorbing organic contaminants.
